(19) United States
(12) Patent Application Publication
(10) Pub. No.: US 2025/0041646 A1
(43) Pub. Date: Feb. 6, 2025

(54) METHODS AND COMPOSITIONS FOR USE IN FIRE CONTROL

(71) Applicant: Solugen, Inc., Houston, TX (US)

(72) Inventors: Jun Su An, Houston, TX (US); Frederyk Ngantung, Houston, TX (US); LoongYi Tan, Houston, TX (US); Amit Desai, Sugar Land, TX (US)

(73) Assignee: Solugen, Inc., Houston, TX (US)

(21) Appl. No.: 18/706,728

(22) PCT Filed: Nov. 2, 2022
(86) PCT No.: PCT/US2022/079174

§ 371 Date: May 1, 2024

Related U.S. Application Data
(60) Provisional application No. 63/274,833, filed on Nov. 2, 2021.

(51) Int. Cl. A62D 1/00

(52) U.S. Cl. CPC A62D 1/0035

(57) ABSTRACT

A fire mitigating composition comprising (i) a sugar derivative and (ii) a solvent. A fire extinguisher, comprising (i) a sugar derivative, (ii) a solvent and, (iii) a propellent. An article, comprising a wood-containing material having a fire-resistant coating comprising a blend of glucaric acid and gluconic acid. A method of suppressing a fire, comprising applying topically to the surface of a fire or proximate to a fire, a fire mitigating composition comprising a sugar derivative wherein the sugar derivative is selected from the group consisting of an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof and combinations thereof.

### CROSS-REFERENCE TO RELATED APPLICATIONS

This application is a 35 U.S.C. § 371 national stage application of PCT/US2022/079174 filed Nov. 2, 2022 and entitled “Methods and Compositions for Use in Fire Control,” which claims priority to U.S. Provisional Application Ser. No. 63/274,833 filed Nov. 2, 2021 and entitled “METHODS AND COMPOSITIONS FOR FIRE CONTROL” and, each of which is hereby incorporated herein by reference in its entirety for all purposes.

### TECHNICAL FIELD

The present disclosure relates generally to compositions and methods for use in fire-mitigation. More specifically, the present disclosure relates to compositions and methods for fire retardation, fire suppression, and/or fire extinguishing.

### BACKGROUND

Forest, brush, and grassland fires destroy acres of natural and suburban landscapes each year. This destruction is not only in terms of a loss of timber, wildlife and livestock, but also in erosion, disruption to watershed equilibria, and related problems in natural environments. Climate change and global warming has led to an exponential increase in the number of wildfires occurring in the United States. In 2010, 3.4 million acres of land were burned as a result of wildfires. A decade later, the acres of land burned increased to 10.1 million acres. There has not only been an increase in the number of wildfires but, consequently, there has also been an increase in the extent of damage (e.g., acres burned) these fires have caused. As a result of these dramatic increases in fire occurrence, the usage of fire retardants has also increased in a dramatic manner. For example, during a single incident, the Dixie Fire in California, 21 million gallons of flame-retardant mixture was used, which was larger than the total amount of flame-retardant mixture used in 2016 by the United States Fire Service (USFS).

While many of these flame-retardant mixtures are effective, their use is restricted because they contain phosphate-containing chemicals which are known to detrimentally affect water resources and certain plant and wildlife species. For example, the use of phosphate-containing chemicals near bodies of water can lead to eutrophication and as a result high aquatic toxicity. The USFS has “exclusion zones”, for example, 100 foot to 300 foot buffer zones are placed around waterways and habitats for some threatened, endangered, and sensitive species in order to avoid application of flame-retardant mixtures in those areas.

Furthermore, the same phosphate-containing fire retardants are commonly used in the production of fire-retardant wood and fire retardant-wood coatings. Phosphate-based fire retardants are effective for timber or wood because they work to promote timber char formation and deprive the gas phase of further volatile decomposition products. Specifically, phosphate-containing fire retardants are known to interrupt the cycle of free radical generation in the timber burning process while remaining stable at the flaming conditions in a wood or timber fire. However, phosphate-containing fire retardants for timber have significant performance issues in addition to the aforementioned environmental issues. For example, timber treated with a phosphate-based fire retardant is known to have significant reductions in the timber strength. This reduction in timber strength is particularly disadvantageous in applications where the treated wood is exposed to elevated temperatures such as plywood roof sheathing.

There exists an ongoing need for effective fire-mitigation compositions and methods of using same that do not suffer from the drawbacks associated with the use of phosphates.

### SUMMARY

Disclosed herein is a fire mitigating composition comprising (i) a sugar derivative and (ii) a solvent.

Also disclosed herein is a fire extinguisher, comprising (i) a sugar derivative, (ii) a solvent and, (iii) a propellent. An article, comprising a wood-containing material having a fire-resistant coating comprising a blend of glucaric acid and gluconic acid.

Also disclosed herein is a method of suppressing a fire, comprising applying topically to the surface of a fire or proximate to a fire, a fire mitigating composition comprising a sugar derivative wherein the sugar derivative is selected from the group consisting of an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids. galactonic acid, galactaric acid, glutamic acid, glucodialdose, 2-ketoglucose, glucodiamine, glycoaldehyde, glyoxal, salts thereof, lactones thereof and combinations thereof.

### BRIEF DESCRIPTION OF DRAWINGS

For a detailed description of the aspects of the disclosed processes and systems, reference will now be made to the accompanying drawings in which:

FIG. 1 is graph of the thermal stability of a fire mitigating composition (FMC) of the type disclosed herein.

FIGS. 2A-9A provide the heat release curve for the samples from Example 2.

FIGS. 2B-9B provide photographs of the char samples for the samples from Example 2.

### DETAILED DESCRIPTION

In one or more aspects, the compositions disclosed herein function as fire retardants. Herein a fire retardant refers to a substance that is used to slow down or stop the spread of fire or reduce its intensity. In one or more aspects, a material treated with compositions of the type disclosed herein is fire resistant. Herein the term fire resistant refers to a material that is self-extinguishes when ignited and does not melt or drip when exposed directly to extreme heat. In one or more aspects, the compositions disclosed herein function as fire suppressants. Herein a fire suppressant refers to a material used to control, or in some cases, entirely prevent fires from spreading or occurring. In yet other aspects, the compositions disclosed herein function as fire extinguishing compositions. Herein a fire extinguishing composition refers to an agent that will cool burning heat, smother fuel or remove oxygen so the fire cannot continue to burn. Collectively, the materials disclosed herein mitigate the effects on materials exposed to fire either through resistance, suppression, extinguishment, retardance or a combination thereof and hence the term fire-mitigating composition (FMC) is used to these materials irrespective of their mode of action.

In an aspect, the FMC comprises a sugar derivative, additionally or alternatively, an oxidized sugar derivative. In another aspect, the FMC comprises a blend of sugar derivatives.

In one or more aspects, the sugar derivative is a biochelant. Herein, a chelant, also termed a sequestrant or a chelating agent, refers to a molecule capable of bonding a metal. The chelating agent is a ligand that contains two or more electron-donating groups so that more than one bond forms between each of the atoms on the ligand to the metal. This bond can also be dative or a coordinating covalent bond meaning the electrons from each electronegative atom provides both electrons to form the bond to the metal center. In one or more aspects, the chelant is a biochelant. As used herein, the prefix “bio” indicates production by a biological process such as from the activity of an enzyme catalyst.

In one or more aspects, the sugar derivative comprises a glucose oxidation product, a gluconic acid oxidation product, a gluconate, glucaric acid glutamic acid, glucodialdose, gluconic erythorbic acid, 2-ketoglucose, salts thereof, lactones thereof, or combinations thereof. The glucose oxidation product, gluconic acid oxidation product, or combination thereof may be buffered to a suitable pH. Buffering can be carried out using any suitable methodology such as by using a pH adjusting material in an amount of from about 1 weight percent (wt. %) to about 10 wt. %, alternatively from about 1 wt. % to about 3 wt. %, or alternatively from about 5 wt. % to about 9 wt. % based on the total weight of the sugar derivative. In one or more aspects, the sugar derivative comprises from about 1 wt. % to about 8 wt. % of a caustic solution in a 20 wt. % gluconate solution.

Additionally or alternatively, the sugar derivative comprises a buffered glucose oxidation product, a buffered gluconic acid oxidation product or combinations thereof. In such aspects, the buffered glucose oxidation product, the buffered gluconic acid oxidation product, or combinations thereof are buffered to a suitable pH such as from about 6 to about 7, using any suitable acid or base such as sodium hydroxide. In such aspects, the sugar derivative comprises a mixture of gluconic acid and glucaric acid, and further comprises a minor component species comprising n-keto-acids, C2-C6 diacids, or combinations thereof. In one or more aspects, the sugar derivative comprises BIOCHELATE™ metal chelation product commercially available from Solugen, Houston Texas.

In one or more aspects, the sugar derivative comprises glucaric acid, glucodialdose, gluconic acid, erythorbic acid, 2-ketoglucose, salts thereof, derivatives thereof or a combination thereof. Without wishing to be limited by theory, glucaric acid, glucodialdose, gluconic acid, erythorbic acid, 2-ketoglucose can be obtained using any suitable methodology such as via enzymatic or chemoenzymatic oxidation of a saccharide.

In one or more aspects, the sugar is derived from glucose. For example, an oxidation biocatalyst or oxidation catalyst may be contacted with the sugar (e.g., glucose) under conditions resulting in the formation of a sugar derivative suitable for use in an FMC. In one or more aspects, the sugar derivative is selected from the group consisting essentially of aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof and combinations thereof.

The sugar derivative may be present in the FMC in amounts ranging from about 30 wt. % to about 90 wt. %, additionally or alternatively, from about 5 wt. % to about 20 wt. % or, additionally or alternatively, from about 10 wt. % to about 50 wt. % based on the total weight of the FMC.

In one or more aspects, a sugar derivative (e.g., glucaric acid) used in the present disclosure is a salt comprising a countercation. Countercations suitable for use in the disclosure include, but are not limited to silicates, borates, aluminates, aluminum, calcium, magnesium, ammonium ion, sodium, potassium, cesium, strontium, an alkali metal, an alkaline earth metal or a combination thereof. In one or more aspects, the counter cation comprises potassium, sodium, aluminum, ammonium, magnesium, iron or combinations thereof.

In one or more aspects, the FMC additionally comprises additives conventionally utilized in compositions used to treat contain or control the spread of fire, Nonlimiting examples of such additives include potassium bicarbonate (KHCO3), liquid water, evaporating fluorocarbons, propelling agents, ammonium phosphate, ammonium sulfate, barium sulfate, silicon oil, sodium bicarbonate, ammonium phosphate, ammonium polyphosphate, ammonium sulfate, ammonium chloride, sodium carbonate, guanylurea phosphate, guanidine phosphate, melamine phosphate, borax, boric acid, phosphonates, dicyandiamide, phosphoric acid, a corrosion inhibitor, thickening agent, coloring agent, surfactant, stabilizer and a combination thereof. In one or more aspects, the FMC further comprises a corrosion inhibitor such as tolytriazole, benzotriazole, anhydrous sodium molydbate, sodium molybdate dihydrate and combinations thereof.

In one or more aspects, the FMC further comprises a thickening agent such as cellulose, carboxyl methyl cellulose, xanthan gum, rhamsan gum, welan gum, diutan gum, guar, carboxy methyl-guar (CMG), hydroxy propyl guar (HPG), carboxy methyl hydroxy propyl guar (CMHPG), and combinations thereof. In one or more aspects, a thickening agent suitable for use in the present disclosure can be crosslinked using borates, aluminates, silicates, zeolites, and combinations thereof. Such additives may be included in an FMC of the type disclosed herein in an amount sufficient to meet some user and/or process need.

In aspects where the additive is a phosphate-containing compound, the amount of phosphate-containing compound in an FMC of the present disclosure may be less than about 20 wt. %, additionally or alternatively, less than about 10 wt. %, additionally or alternatively, less than about 5 wt. %, additionally or alternatively, less than about 1 wt. %, additionally or alternatively, less than about 0.5 wt. % or additionally or alternatively, less than about 0.1 wt. % based on the total weight of the FMC. For example, the FMCs of the present disclosure may be substantially free of phosphate-containing compounds. In an additional or alternative aspect, FMCs of the present disclosure exclude phosphate-containing compounds.

In one or more aspects, an FMC of the type disclosed herein further comprises a solvent. Solvents suitable for use in the FMC include without limitation water, carbon dioxide, urea, glycerol, glycols, or combinations thereof. In one or more aspects, the solvent is present in an amount sufficient to meet some user and/or process need. For example, the solvent may be present in an amount of from about 20 to about 80, alternatively from about 0.1 to about 10, or alternatively from about 5 to about 60% wt. In one or more aspects, the solvent is present in an effective amount; alternatively, the solvent comprises the remainder of the FMC when all other components of the FMC are accounted for.

Application of the FMC solution may be carried out using any suitable methodology and/or equipment. For example, an FMC may be disposed within a fire extinguisher and used to cool a heated, burning, smoldering, and/or inflamed material, to smother fuel, and/or remove oxygen so that a fire cannot continue to burn. In such aspects, also disposed within the fire extinguisher may be a propellant such as nitrogen or compressed carbon dioxide.

In another aspect an FMC of the type disclosed herein may be applied to a wood surface such as lumber or timber where the FMC forms a fire-retarding coating that functions to slow down or stop the spread of fire or reduce its intensity. The fire retardant coating may be of any suitable thickness and in one or more aspects is a continuous coating that covers greater than about 50% of the material's surface, alternatively greater than about 75% of the material's surface. In alternative aspects, the fire retardant coating is of any suitable thickness and is a discontinuous coating that covers greater than about 50% of the material's surface, alternatively greater than about 75% of the material's surface.

In another aspect, an FMC solution is applied topically to the surface area above a fire and/or proximate to a fire to reach the combusting fuel and suppress and/or extinguish such that the fire is controlled, prevented from occurring, and/or prevented from spreading such as during a wildfire. Herein a wildfire refers to a large, destructive fire that spreads quickly over woodland or brush. In other aspects, an FMC may be used in the treatment of a building fire, a brush fire and/or controlled burns.

In one or more aspects, application of an FMC solution is ground-based and may utilize techniques such as hose spraying of the solution via a vehicle mounted spraying device (e.g., ATV mounted sprayers, truck-bed mounted sprayers, trailer mounted sprayers, tractor mounted sprayers, etc.). Additionally or alternatively, the FMC solution application is aerial and may employ aerial firefighting methodologies such as airtankers, spray planes, waterbombers, or helicopters. In one or more aspects the FMC solution application is aerial and employs a helicopter equipped with a Bambi bucket and a solution storage container. In such aspects, the FMC solution may be transferred from the solution storage container to the bucket which then deposits the transferred FMC solution onto an area above or in proximity to a wildfire.

In yet other aspects, an FMC of the type disclosed herein may be applied to fire-danger areas in order to reduce the flammability of fuel disposed within such areas. Herein fire danger refers to a broad scale assessment that describe the conditions reflecting the potential, over a large area, for a fire to ignite, spread and require suppression action.

An FMC of the present disclosure may further be characterized by an aqua toxicity, or toxicity to aquatic organisms, of equal to or less than about 50 g/L, alternatively equal to or less than about 40 g/L, alternatively equal to or less than about alternatively 30 g/L or alternatively from about 25 g/L to equal to or less than about 50 g/L. Aqua toxicity may be evaluated using any suitable methodology such as ASTM E-729-96 (Reapproved 2002) Standard Guide for Conducting Acute Toxicity Tests on Test Materials with Fishes, Macroinvertebrates and Amphibians. Solugen product (Liquid Biochelate), For example, BIOCHELATE™, a mixture of oxidized glucose products commercially available from Solugen Inc., was found to be non-toxic to species such as Daphnia magna according to the protocol set forth in the Organization for Economic Cooperation and Development (OECD) Test No. 202.

### ADDITIONAL DISCLOSURE

The following are non-limiting, specific aspects in accordance with the present disclosure:

A first aspect which is a fire mitigating composition comprising (i) a sugar derivative and (ii) a solvent.

A second aspect which is the composition of the first aspect wherein the sugar derivative is selected from the group consisting of an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids. galactonic acid, galactaric acid, glutamic acid, glucodialdose, 2-ketoglucose, glucodiamine, glycoaldehyde, glyoxal, salts thereof, lactones thereof and combinations thereof.

A third aspect which is the composition of any of the first through second aspects wherein the sugar derivative comprises a blend of glucaric acid, gluconate, gluconic acid and gluconate.

A fourth aspect which is the composition of any of the first through third aspects wherein the sugar derivative comprises a blend of glucaric acid and gluconic acid.

A fifth aspect which is the composition of any of the first through fourth aspects wherein the composition comprises equal to or less than about 20 wt. % of a phosphate-based compound based on the total weight of the composition.

A sixth aspect which is the composition of any of the first through fifth aspects wherein the sugar derivative is present in an amount of from about 30 wt. % to about 90 wt. % based on the total weight of the composition.

A seventh aspect which is the composition of any of the first through sixth aspects further comprising silicates, aluminates, borates, aluminum, calcium, magnesium, ammonium, sodium, potassium, cesium, strontium, iron, an alkali metal, an alkaline earth metal or a combination thereof.

An eighth aspect which is the composition of any of the first through seventh aspects further comprising ammonium phosphate, ammonium polyphosphate, ammonium sulfate, ammonium chloride, sodium carbonate, sodium bicarbonate, guanylurea phosphate, guanidine phosphate, melamine phosphate, borax, boric acid, phosphonates, dicyandiamide, phosphoric acid, orthophosphates, polyphosphates, hexametaphosphates, or a combination thereof.

A ninth aspect which is the composition of any of the first through eighth aspects wherein the solvent comprises water, carbon dioxide, urea, glycerol, glycols, or a combination thereof.

A tenth aspect which is a fire extinguisher, comprising (i) a sugar derivative, (ii) a solvent and, (iii) a propellent.

An eleventh aspect which is the extinguisher of the tenth aspect wherein the sugar derivative is selected from the group consisting of an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof and combinations thereof.

A twelfth aspect which is the extinguisher of any of the tenth through eleventh aspects wherein the sugar derivative comprises a blend of glucaric acid, gluconate, gluconic acid and gluconate.

A thirteenth aspect which is the extinguisher of any of the tenth through twelfth aspects wherein the solvent comprises water, carbon dioxide, urea, glycerol, glycols, or a combination thereof.

A fourteenth aspect which is an article, comprising a wood-containing material having a fire-resistant coating comprising a blend of glucaric acid and gluconic acid.

A fifteenth aspect which is a method of suppressing a fire, comprising applying topically to the surface of a fire or proximate to a fire, a fire mitigating composition comprising a sugar derivative wherein the sugar derivative is selected from the group consisting of an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids. galactonic acid, galactaric acid, glutamic acid, glucodialdose, 2-ketoglucose, glucodiamine, glycoaldehyde, glyoxal, salts thereof, lactones thereof and combinations thereof.

A sixteenth aspect which is the method of the fifteenth aspect wherein the sugar derivative comprises a blend of glucaric acid, gluconate, gluconic acid and gluconate.

A seventeenth aspect which is the method of any of the fifteenth through sixteenth aspects wherein composition comprises a solvent and wherein the solvent comprises water, carbon dioxide, urea, glycerol, glycols, or a combination thereof.

An eighteenth aspect which is the method of any of the fifteenth through seventeenth aspects wherein the composition further comprises at least one additive wherein the additive comprises of a corrosion inhibitor, thickening agent, coloring agent, surfactant, stabilizer or a combination thereof.

A nineteenth aspect which is the method of any of the fifteenth through eighteenth aspects where in the corrosion inhibitor comprises of tolytriazole, benzotriazole, anhydrous sodium molydbate, sodium molybdate dihydrate and combinations thereof.

A twentieth aspect which is the method of any of the fifteenth through nineteenth aspects wherein the thickening agent comprises of, cellulose, carboxyl methyl cellulose, xanthan gum, rhamsan gum, welan gum, diutan gum, guar, Carboxy Methyl-Guar (CMG), Hydroxy Propyl Guar (HPG), Carboxy Methyl Hydroxy Propyl Guar (CMHPG), and combinations thereof.

A twenty-first aspect which is the method of any of the fifteenth through twentieth aspects wherein the fire is a wildfire, building fire, brush fire, controlled burns, and other fires.

A twenty-second aspect which is the method of any of the fifteenth through twenty-first aspects wherein application comprises hose spraying of the solution via a vehicle mounted spraying device.

A twenty-third aspect which is the method of any of the fifteenth through twenty-second aspects wherein application is carried out using airtankers, spray planes, waterbombers, helicopters, or a combination thereof.

A twenty-fourth aspect which is the method of any of the fifteenth through twenty-third aspects wherein application comprises of pre-treating a surface to prevent fires.

A twenty-fifth aspect which is the method of the twentieth aspect wherein the thickening agent is crosslinked using borates, aluminates, silicates, zeolites, and combinations thereof.

### EXAMPLES

The subject matter having been generally described, the following examples are given as particular aspects of the disclosure and are included to demonstrate the practice and advantages thereof. Those of skill in the art should, in light of the present disclosure, appreciate that many changes can be made in the specific aspects which are disclosed and still obtain a like or similar result without departing from the scope of the subject matter of the instant disclosure. It is understood that the examples are given by way of illustration and are not intended to limit the specification of the claims to follow in any manner.

### Example 1

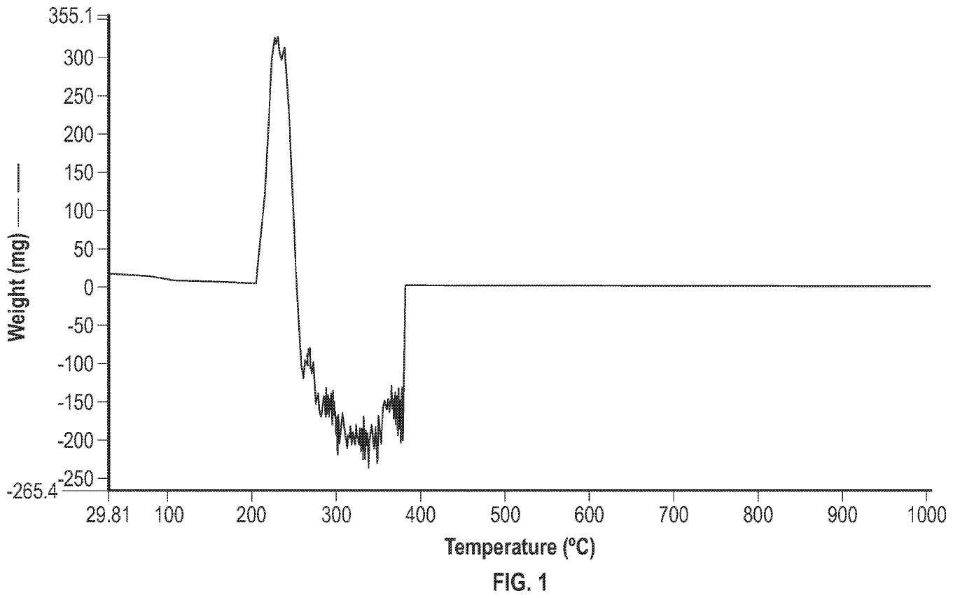

Using ASTM E1848 test, the thermal stability and/or decomposition of an FMC of the type disclosed herein was evaluated. The results are presented in FIG. 1. As seen in FIG. 1, the weight v. temperature graph, the FMC of this disclosure exhibited a thermal expansion property during heating. This unexpected result is indicative of a fire retarder, for example, and not intending to be bound by theory, as the expansion allows for better thermal insulation, and slows down fires and heat transfer. In this experiment, the FMC was a mixture of glucaric acid (and its lactones), sodium glucarate, sodium gluconate, and gluconic acid (and its lactones).

### Example 2

The inherent flammability of FMCs of the type disclosed herein was measured using a cone calorimeter in accordance with ASTM E-1354/ISO 5660 which uses oxygen consumption calorimetry. The cone calorimeter represents a well-ventilated fire event, with the radiant heater representing another item on fire radiating heat onto the material to be tested. In this regard, the cone calorimeter is a reasonable surrogate test for evaluating potential flame-retardant chemicals to be applied to dry plant matter in forests or wildland areas. Specifically, the heater on the cone calorimeter represents another material in the wildland area on fire, radiating heat onto the dry plant matter.

The following observations were carried out for each FMC sample: smoke measurements, oxygen consumption, mass loss as the sample pyrolyzes during heat exposure, and measurement of CO₂/CO production as a function of time during sample combustion. Specifically, a large bag of pine needles was obtained from a local Christmas Tree farm and allowed to dry out in the lab at room temperature and pressure for approximately 14 days. A 60 g sample of the pine needles was placed on a 12×12 inch tray lined with aluminum foil and then sprayed with 60 g of the sample solution just prior to testing. The method used here to spray the solutions onto the pine needles was meant to be reproducible in how the solutions were applied, but not yield uniform coating of every pine needle used in testing. Since the pine needle arrangements were random, as would be seen in the real world, the solutions sprayed onto the needles would also be random. Some needles may have been fully coated, whereas others deeper into the pine needle layers may not be coated evenly. This is what one would expect to see in the real world when the chemical is sprayed from a hose on an area of dried vegetation, or when dropped from an airplane. The coating will never be even, but it should be sufficiently coated to mostly prevent/delay ignition and flame spread.

Sample 1 was a control sample with pine needles having no materials applied. Sample 2 were pine needles sprayed with an aqueous solution of 20 wt. % potassium citrate. Sample 3 were pine needles sprayed with an aqueous solution of 20 wt. % ammonium phosphate. Sample 4 were pine needles sprayed with an aqueous solution of 20 wt. % potassium gluconate. Sample 5 were pine needles sprayed with an aqueous solution having a 1:1 mixture of 20 wt. % ammonium phosphate and 20 wt. % potassium gluconate. Sample 6 were pine needles sprayed with a mixture of glucaric acid, sodium glucarate, gluconic acid, sodium gluconate, sodium aluminate, and water designated GOGA-SAG. Sample 7 were pine needles sprayed with a mixture of mixture of gluconic acid, glucaric acid, and water neutralized using potassium hydroxide to a pH of 7.3, designated K-GOGA. Sample 8 were pine needles sprayed with a mixture of gluconic acid, sodium gluconate, sodium aluminate, and water designated LG-SAG. Triplicates of each sample were prepared.

A sample (˜30 g) of the treated pine needles was weighed into a heavy-duty foil sample tray, pressed down into that container and then immediately tested in the cone calorimeter. Cone calorimeter experiments were conducted on a Deatak (McHenry, IL USA) CC-2 Cone calorimeter at 1 heat fluxes (35 kW/m2) with an exhaust flow of 24 L/s using the standardized cone calorimeter procedure (ASTM E-1354-22). Samples were wrapped in aluminum foil on one side as per the ASTM E1354 standard and no frame or grid was used. Data collected from all samples is estimated to have an error of +10% and were calculated using a specimen surface area of 100 cm2. All samples were tested in triplicate as per the ASTM E1354 standard.

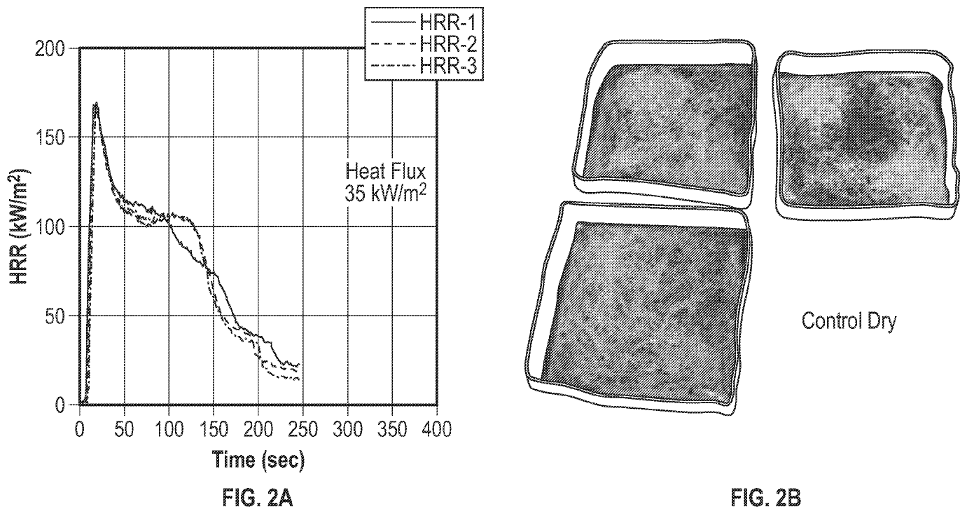

Sample 1 contained dry pine needle that did not have any test solution sprayed on them and were tested as mentioned in the experimental section (left to dry in the lab, but otherwise untreated). Upon exposure to the cone heater, these samples began to smoke immediately and ignited quickly in about 7 seconds then burned for ˜2-3 minutes. There was not a lot of smoke during the test and the samples smoldered throughout the test and continued to smolder for a short time after removal from the heat. A heat release curve (HRC) was prepared by plotting the heat release rate (HRR) as a function of time The HRC of Sample 1, FIG. 2A, shows good reproducibility for the peak HRR value, but some scatter after 100 seconds was observed due to differences in how the pine needles were packed into the sample holder. The final char, FIG. 2B, shows a small flat pile of white and black needle ash.

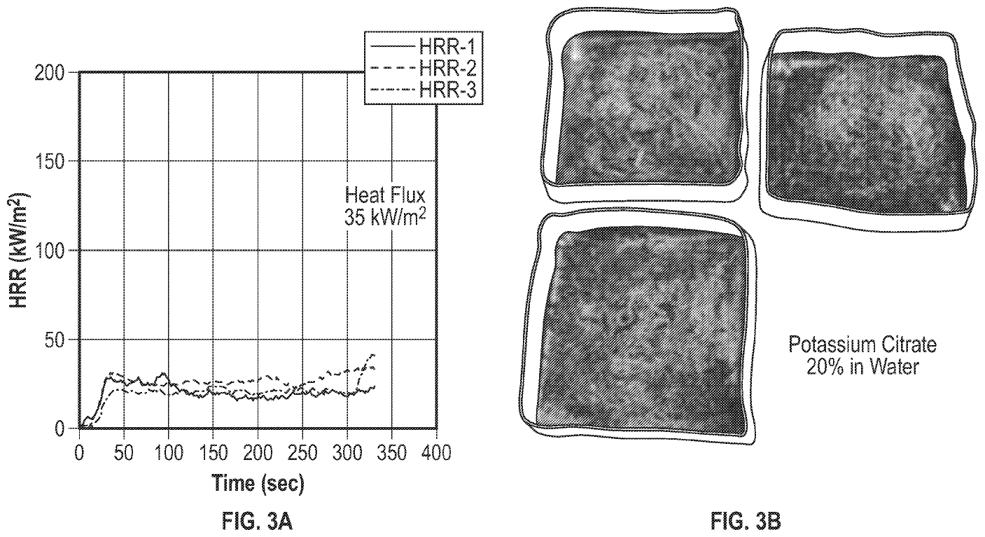

Sample 2 contained dry pine needle samples which were sprayed with an 20% aqueous solution of potassium citrate. Upon exposure to the cone heater, the sample began to rise up quickly in the center of the tray and cover the spark ignitor. Some occasional arcing between the spark ignitor and the needles touching the spark ignitor was observed during the test. After exposure to the heater, the sample began to smoke quickly in about 7 seconds but stopped smoking after about 2 minutes. After a long time of exposure, only two of the samples ignited toward the end of the test and then burned very slowly for another ˜6-7 minutes. There was more smoke during the test with these samples since they never really ignited, but did smoke/release mass during heating. There was also some smoldering noted with the pine needles throughout the test. The HRC curve FIG. 3A shows very little heat release since the materials never really ignited, and when they did (HRR-2 and HRR-3), the flames observed were very small and generated very little additional heat. In fact, the flames observed were often isolated at one corner of the sample and never fully ignited the surface of the pine needle “mat” during the test. The final char, FIG. 3B, shows a larger pile of white and black needle ash. The higher levels of black color indicate that the salt solutions did allow for more carbonization/char formation to occur during heat exposure

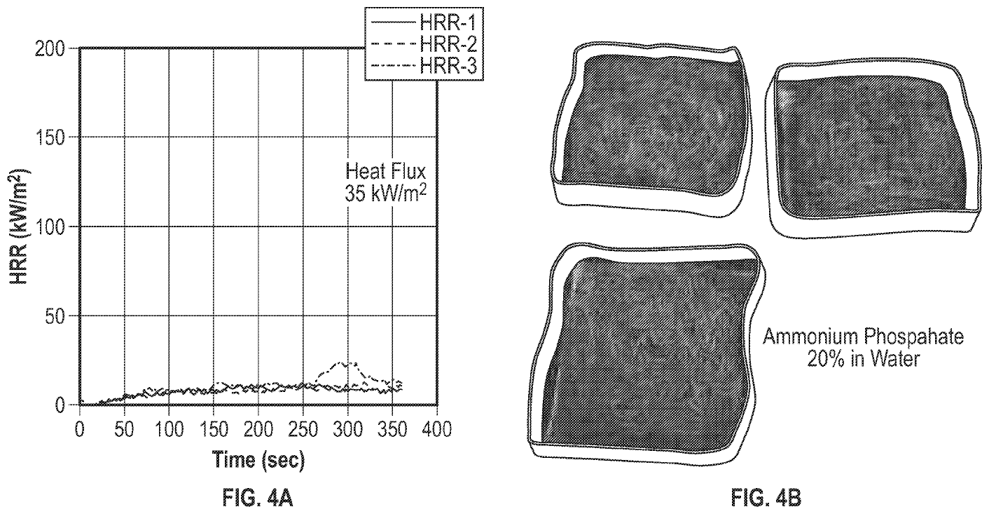

Sample 3 contained dry pine needle samples sprayed with an aqueous 20% ammonium phosphate solution. Upon exposure to the cone heater, these samples began to rise up quickly in the center of the tray and tried to cover/connect with the spark ignitor. The samples began to smoke quickly in about 6 seconds. The first 2 samples did not ignite and the test was stopped after 5 minutes exposure. The third test did ignite at about 4 ½ minutes and extinguished about 40 seconds later. Because the samples never ignited, and no smoldering was observed during the entire test, there was more smoke observed, as one would expect for a material which is carbonizing, but not smoldering or igniting. The results fit with what is known about ammonium phosphate and its ability to carbonize/char cellulosic materials, and indeed, the final char, FIG. 4B, supports this with the piles of black needles formed at the end, vs. white + black char/ash seen for other samples. The HRC, FIG. 4A, shows how little heat was generated during the test, and shows the one ignition event for HRR-3, which was a very small flame on one side of the sample.

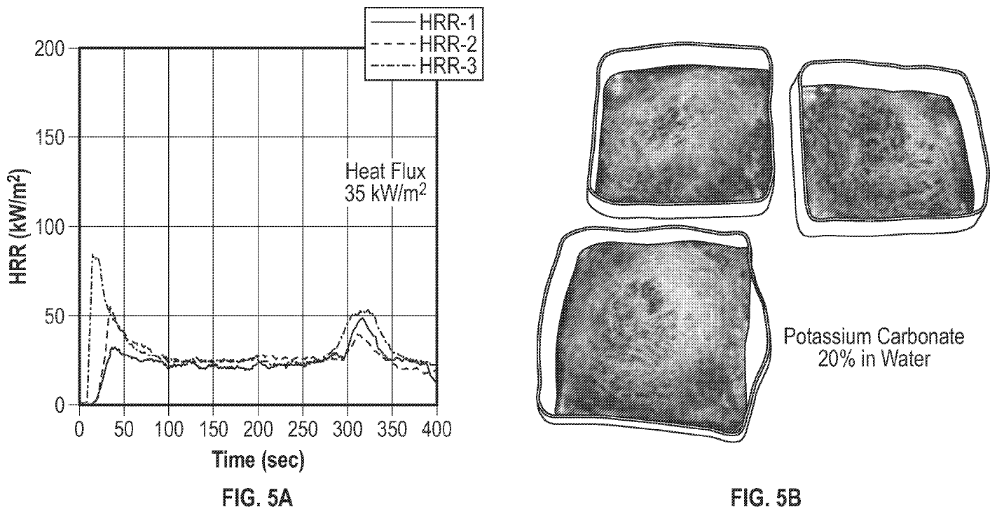

Sample 4 contained dry pine needles sprayed with an aqueous 20% solution of potassium gluconate. Upon exposure to the cone heater, these samples began to rise up quickly in the center of the tray and also tried to connect with and cover the spark igniter. The pine needles started to smoke in about 9 seconds and smolder at approximately 15 seconds. The samples had a very brief, approximately 5 seconds, flash flamed early at about 15 seconds, went out and reignited later at about the 5 minute mark and burned for ˜30 seconds. There was some white smoke during the test with these samples. The HRC, FIG. 5A, shows the initial flash flame and then a steady slow smolder followed by the second ignition event. The final char, FIG. 5B, shows a large pile of white and black needle ash. The results indicate that this salt is not as effective a FMC as Sample 2, and gave off some consistent amounts of heat release during the test, but the heat release is lower for this treated material when compared to the control (uncoated) samples.

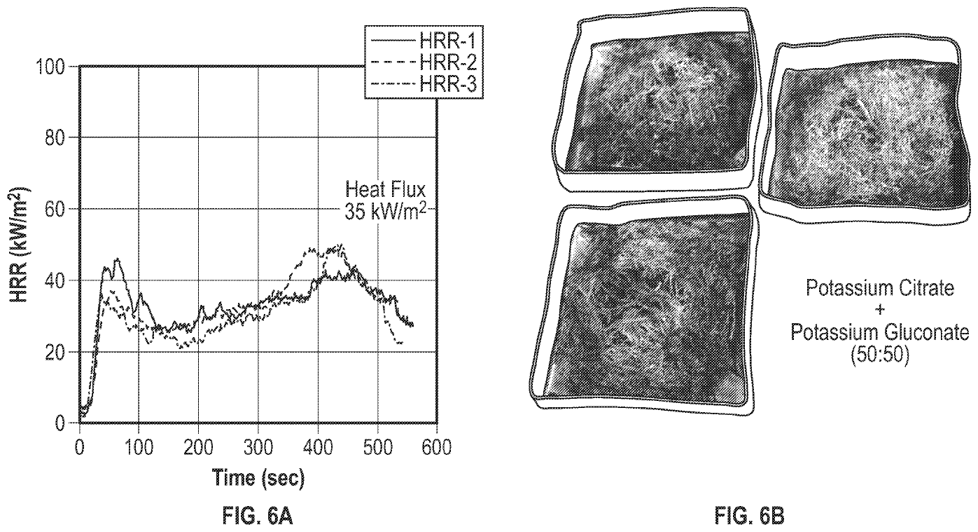

Sample 5 contained dry pine needles sprayed with an aqueous solution that is a 20% mixture of potassium gluconate and potassium citrate: Upon exposure to the cone heater, the needles began to smoke and move towards the center of the foil. The pine needles ignited slowly in about 380 seconds and then burned for about 90 seconds. There was not a lot of smoke during the test and the samples smoldered throughout and continued to smolder for a short time after removal from the heat. The HRC FIG. 6A shows a bimodal curve of very low intensity. The first peak is from the smoldering onset of the sample and the second peak is from the very small flame event when ignition was actually recorded. The final char FIG. 6B shows a tall pile of white and black needle ash.

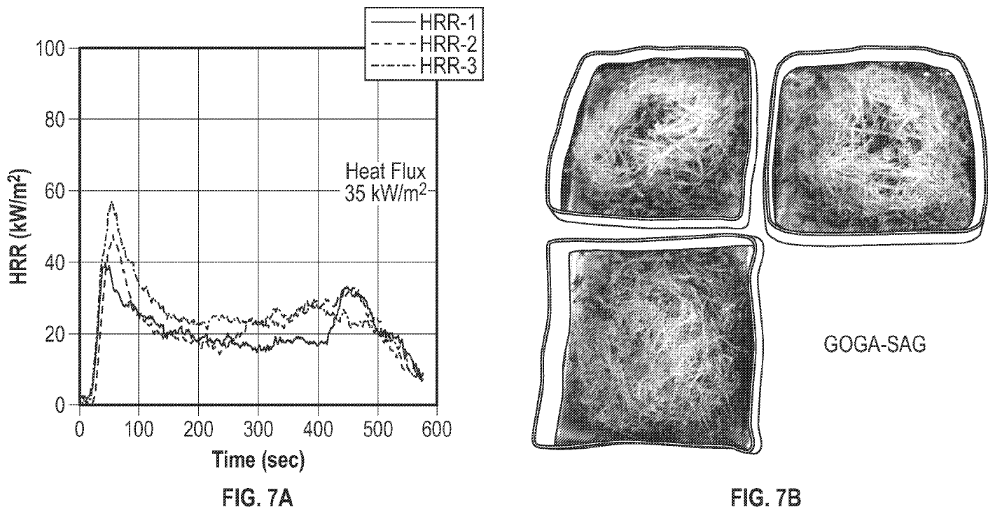

Sample 6 contained dry pine needles sprayed with an aqueous solution of GOGA-SAG. Upon exposure to the cone heater, the samples began to smoke and move towards the center of the foil. They ignited slowly in about 411 seconds then burned for about 90 seconds. The HRC FIG. 7A shows the initial peak of heat release from the onset of smoldering (with a slight flash of flame that died back to smolder) of the needles at the start of the test, followed by a steady low smolder and then the second ignition event. The final char, FIG. 7B, shows a larger pile of white and black needle ash.

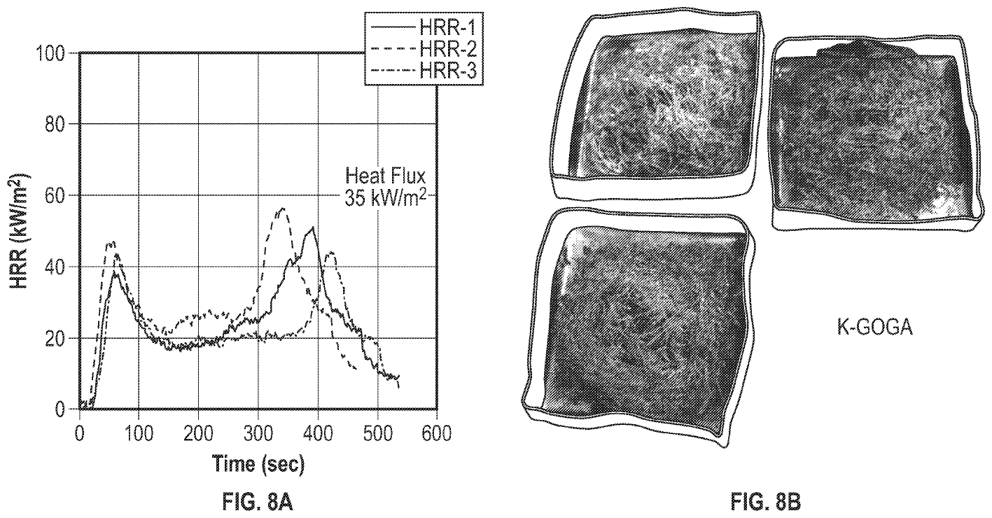

Sample 7 contained dry pine needles sprayed with an aqueous solution of K-GOGA. Upon exposure to the cone heater, the samples began to smoke and move towards the center of the foil. They ignited slowly in about 332 seconds then burned for about 90 seconds. These samples also smoldered throughout the test. The HRC, FIG. 8A, shows a bimodal curve with the onset of smoldering (with a slight flash of flame that died back to smolder) of the needles at the start of the test, followed by a steady low smolder and then the second ignition event. The final char, FIG. 8B, shows a larger pile of mostly black needle ash.

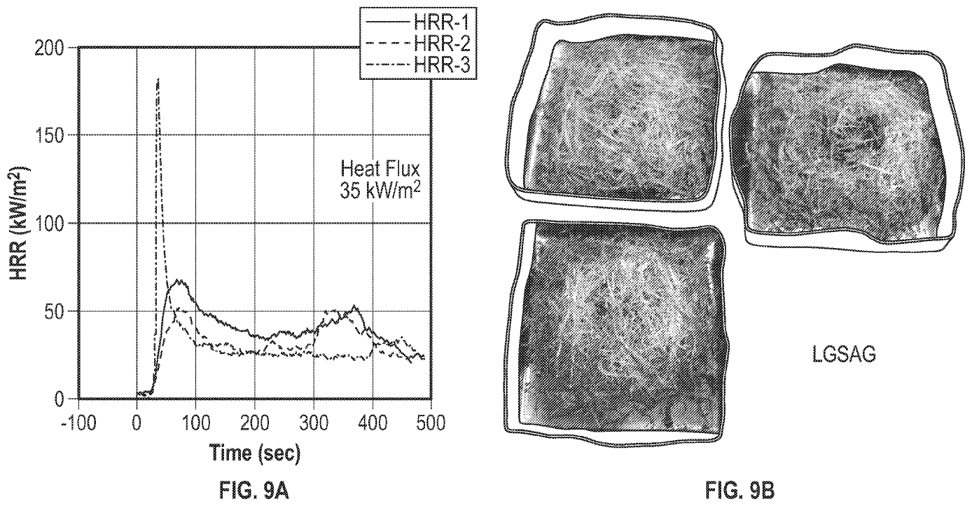

Sample 8 contained dry pine needles sprayed with an aqueous solution of LG-SAG. Upon exposure to the cone heater, these samples began to rise up quickly in the center of the tray and cover the spark ignitor. They started to smoke in about 10 seconds, ignited in about 332 seconds and burned for 90 seconds. There was not much white smoke released during the test with these samples. The HRC, FIG. 9A, shows the initial smolder, a steady low smolder and then the second ignition event. The final char, FIG. 9B, shows a large pile of white and black needle ash. Sample HRR-3 had a large initial flash flame that lasted about 4 seconds, went out and then reignited at about 400 seconds and burned for about 1 minute.

The results are summarized in Table 1 which presents the averaged values. The specific characteristics calculated are as follows:

Time to ignition (Tig): Measured in seconds, this is the time to sustained ignition of the sample. Interpretation of this measurement assumes that earlier times to ignition mean that the sample is easier to ignite under a particular heat flux.

Heat Release Rate (HRR): The rate of heat release, in units of kW/m2, as measured by oxygen consumption calorimetry.

Peak Heat Release Rate (Peak HRR): The maximum value of the heat release rate during the combustion of the sample. The higher the peak HRR, the more likely that flame will self-propagate on the sample in the absence of an external flame or ignition source. Also, the higher the peak HRR, the more likely that the burning object can cause nearby objects to ignite.

Time to Peak HRR: The time to maximum heat release rate. This value roughly correlates the time it takes for a material to reach its peak heat output, which would in turn sustain flame propagation or lead to additional flame spread. Delays in time to peak HRR are inferred to mean that flame spread will be slower in that particular sample, and earlier time to peak HRR is inferred to mean that the flame spread will be rapid across the sample surface once it has ignited.

Time to Peak HRR: Time to Ignition (Time to Peak HRR-Tig): This is the time in seconds that it takes for the peak HRR to occur after ignition rather than at the start of the test (the previous measurement). This can be meaningful in understanding how fast the sample reaches its maximum energy release after ignition, which can suggest how fast the fire grows if the sample itself catches fire.

Average Heat Release Rate (Avg HRR): The average value of heat release rate over the entire heat release rate curve for the material during combustion of the sample.

Starting Mass, Total Mass Lost, Weight % Lost: These measurements are taken from the load cell of the cone calorimeter at the beginning and end of the experiment to see how much total material from the sample was pyrolyzed/burned away during the experiment.

Total Heat Release (THR): This is measured in units of MJ/m2 and is basically the area under the heat release rate curve, representing the total heat released from the sample during burning. The higher the THR, the higher the energy content of the tested sample. THR can be correlated roughly to the fuel load of a material in a fire, and is often affected by polymer chemical structure.

Total Smoke Release: This is the total amount of smoke generated by the sample during burning in the cone calorimeter. The higher the value, the more smoke generated either due to incomplete combustion of the sample, or due to polymer chemical structure.

Maximum Average Rate of Heat Emission (MARHE): This is a fire safety engineering parameter, i and is the maximum value of the average heat rate emission, which is defined as the cumulative heat release (THR) from t=0 to time t divided by time t. The MARHE can best be thought of as an ignition modified rate of heat emission parameter, which can be useful to rank materials in terms of ability to support flame spread to other objects.

Fire Growth Rate (FIGRA): This is another fire safety engineering parameter, determined by dividing the peak HRR by the time to peak HRR, giving units of kW/m2 per second. The FIGRA represents the rate of fire growth for a material once exposed to heat, and higher FIGRA suggest faster flame spread and possible ignition of nearby objects.

TABLE 1

| | | | | | | Average | Average | | | | | Avg. | | |
|---|---|---|---|---|---|---|---|---|---|---|---|---|---|---|
| | | Time | | Time | Time | HRR | HRR | | | Total | | Effective | | |
| | Time | to | Peak | to | to | over | over | | | Heat | Total | Heat of | | |
| | to | Flame- | HRR | Peak | Peak | 60 s | 180 s | Starting | Weight | Release | smoke | Com- | | |
| Sample | ignition, | out | (kW/ | HRR | HRR- | (kW/ | (kW/ | Mass | lost | (MJ/ | (m2/ | bustion | MARHE | |
| Description | Tig (s) | (min) | m2) | (s) | Tig (s) | m2) | m2) | (g) | % | m2) | m2) | (MJ/kg) | (kW/m2) | FIGRA |
| Control | 8 | 2:38 | 168 | 19 | 11 | 121 | 95 | 15 | 78 | 19 | 16 | 16 | 215 | 9.0 |
| Potassium | 292 | 6:07 | 36 | 262 | 68 | 29 | 25 | 26 | 81 | 10 | 98 | 5 | 48 | 0.2 |
| Citrate | | | | | | | | | | | | | | |
| Ammonium | 268 | 5:03 | 17 | 306 | 216 | 8 | 6 | 27 | 74 | 3 | 197 | 2 | 18 | 0.1 |
| Phosphate | | | | | | | | | | | | | | |
| Potassium | 289 | 5:47 | 72 | 98 | −191 | 38 | | 26 | 86 | 11 | 104 | 5 | 69 | 3.0 |
| Gluconate | | | | | | | | | | | | | | |
| K Citrate:K | 378 | 7:58 | 48 | 305 | −73 | 44 | 42 | 30 | 83 | 18 | 90 | 7 | 64 | 0.3 |
| Gluconate | | | | | | | | | | | | | | |
| 1:1 | | | | | | | | | | | | | | |
| GOGA- | 412 | 8:20 | 48 | 51 | −361 | 28 | 22 | 30 | 84 | 13 | 81 | 5 | 54 | 0.9 |
| SAG | | | | | | | | | | | | | | |
| K-GOGA | 332 | 6:50 | 51 | 379 | 47 | 42 | 31 | 30 | 81 | 13 | 71 | 5 | 53 | 0.1 |
| LGSAG | 355 | 7:03 | 101 | 59 | −296 | 41 | | 30 | 87 | 17 | 54 | 6 | 84 | 2.3 |

Based upon the results obtained, it appeared that all of the test solutions show some flame-retardant effect on pine needles. Specifically, compared to the uncoated pine needle control samples, all of the coated samples greatly delayed ignition (or never ignited at all) and left behind char residues which slowed the rates of smolder and pyrolysis.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k* (R_{U}-R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. When a feature is described as “optional,” both embodiments with this feature and embodiments without this feature are disclosed. Similarly, the present disclosure contemplates embodiments where this feature is required and embodiments where this feature is specifically excluded. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure.

1. A fire mitigating composition comprising (i) a sugar derivative and (ii) a solvent.

2. The composition of claim 1, wherein the sugar derivative is selected from the group consisting of an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof and combinations thereof.

3. The composition of claim 1, wherein the sugar derivative comprises a blend of glucaric acid, gluconate, gluconic acid and gluconate.

4. The composition of claim 1, wherein the sugar derivative comprises a blend of glucaric acid and gluconic acid.

5. The composition of claim 1, wherein the composition comprises equal to or less than about 20 wt. % of a phosphate-based compound based on the total weight of the composition.

6. The composition of claim 1, wherein the sugar derivative is present in an amount of from about 30 wt. % to about 90 wt. % based on the total weight of the composition.

7. The composition of claim 1, further comprising silicates, aluminates, borates, aluminum, calcium, magnesium, ammonium, sodium, potassium, cesium, strontium, iron, an alkali metal, an alkaline earth metal or a combination thereof.

8. The composition of claim 1, further comprising ammonium phosphate, ammonium polyphosphate, ammonium sulfate, ammonium chloride, sodium carbonate, sodium bicarbonate, guanylurea phosphate, guanidine phosphate, melamine phosphate, borax, boric acid, phosphonates, dicyandiamide, phosphoric acid, orthophosphates, polyphosphates, hexametaphosphates, or a combination thereof.

9. The composition of claim 1, wherein the solvent comprises water, carbon dioxide, urea, glycerol, glycols, or a combination thereof.

10. A fire extinguisher, comprising:
(i) a sugar derivative, (ii) a solvent and, (iii) a propellent.

11. The extinguisher of claim 10, wherein the sugar derivative is selected from the group consisting of an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids. galactonic acid, galactaric acid, glutamic acid, glucodialdose, 2-ketoglucose, glucodiamine, glycoaldehyde, glyoxal, salts thereof, lactones thereof and combinations thereof.

12. The extinguisher of claim 10, wherein the sugar derivative comprises a blend of glucaric acid, gluconate, gluconic acid and gluconate.

13. The extinguisher of claim 10, wherein the solvent comprises water, carbon dioxide, urea, glycerol, glycols, or a combination thereof.

14. An article, comprising a wood-containing material having a fire-resistant coating comprising a blend of glucaric acid and gluconic acid.

15. A method of suppressing a fire, comprising:
applying topically to the surface of a fire or proximate to a fire, a fire mitigating composition comprising a sugar derivative wherein the sugar derivative is selected from the group consisting of an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof and combinations thereof.

16. The method of claim 15, wherein the sugar derivative comprises a blend of glucaric acid, gluconate, gluconic acid and gluconate.

17. The method of claim 15, wherein composition comprises a solvent and wherein the solvent comprises water, carbon dioxide, urea, glycerol, glycols, or a combination thereof.

18. The method of claim 15, wherein the composition further comprises at least one additive wherein the additive comprises a corrosion inhibitor, thickening agent, coloring agent, surfactant, stabilizer or a combination thereof.

19. The method of claim 15, where in the corrosion inhibitor comprises tolytriazole, benzotriazole, anhydrous sodium molydbate, sodium molybdate dihydrate and combinations thereof.

20. The method of claim 15, wherein the thickening agent comprises, cellulose, carboxyl methyl cellulose, xanthan gum, rhamsan gum, welan gum, diutan gum, guar, Carboxy Methyl-Guar (CMG), Hydroxy Propyl Guar (HPG), Carboxy Methyl Hydroxy Propyl Guar (CMHPG), and combinations thereof.

21. The method of claim 15, wherein the fire is a wildfire, building fire, brush fire, controlled burns, and other fires.

22. The method of claim 15, wherein application comprises hose spraying of the solution via a vehicle mounted spraying device.

23. The method of claim 1, wherein application is carried out using airtankers, spray planes, waterbombers, helicopters, or a combination thereof.

24. The method of claim 1, wherein application comprises pre-treating a surface to prevent fires.

25. The method of claim 20, wherein the thickening agent is crosslinked using borates, aluminates, silicates, zeolites, and combinations thereof.
